(19) United States
(12) Patent Application Publication
(10) Pub. No.: US 2019/0150691 A1
(43) Pub. Date: May 23, 2019

(54) BATTERY FOR AUTONOMOUS FLOOR-CLEANING APPARATUS

(71) Applicant: Hongli Song, Beijing (CN)

(72) Inventor: Hongli Song, Beijing (CN)

(21) Appl. No.: 16/170,062

(22) Filed: Oct. 25, 2018

Related U.S. Application Data
(60) Provisional application No. 62/576,862, filed on Oct. 25, 2017.

(51) Int. Cl. A47L 11/40; H01M 10/0525; H01M 10/613; H01M 10/623; H01M 10/654; H01M 10/44

(52) U.S. Cl. CPC A47L 11/4005; H01M 10/0525; H01M 10/613; A47L 2201/022; H01M 10/654; H01M 10/44; H01M 10/623

(57) ABSTRACT

In one aspect, a lithium battery with fast charging capability for an autonomous floor-cleaning apparatus may include a main body, a battery module, a first heat conducting unit, a second heat conducting unit, a first fan unit and a second fan unit. The main body may include a top board, a bottom board, a front side board, a rear side board, a left-side board and a right-side board. When the main body is assembled, it is further sealed by a predetermined type of glue so a receiving space is formed inside the main body, and the main body has a couple air inlets and an air outlet. In one embodiment, the first air inlet is disposed at a lower portion of the left-side board and the second air inlet is disposed at a lower portion of the right-side board; and the air outlet is disposed on the top board.

### CROSS-REFERENCE TO RELATED APPLICATIONS

This application claims priority under 35 U.S.C. § 119 (e) to U.S. Provisional Patent Application Ser. No. 62/576,862, filed on Oct. 25, 2017, the entire contents of which are hereby incorporated by reference.

### FIELD OF THE INVENTION

The present invention relates to an autonomous floor-cleaning apparatus, and more particularly to a lithium battery with fast-charging capability of the autonomous floor-cleaning apparatus.

### BACKGROUND OF THE INVENTION

Generally, an automatic cleaning device is a self-running vacuum cleaner without requiring a manual control operation. Nowadays, in accordance with the pursuit of a reduced cleaning time and enhanced convenience, various designs of automatic cleaning devices have been developed and used. Conventional automatic cleaning devices are all powered by batteries inside the cleaning devices and the electrical capacity of the battery can directly affect the performance of the automatic cleaning device. Therefore, there remains a need for a new and improved battery charging technique to enhance the performance of the automatic cleaning devices.

### SUMMARY OF THE INVENTION

In one aspect, a lithium battery with fast charging capability for an autonomous floor-cleaning apparatus may include a main body, a battery module, a first heat conducting unit, a second heat conducting unit, a first fan unit and a second fan unit. In one embodiment, the main body is made by metals with high heat conduction capability, and the main body may include a top board, a bottom board, a front side board, a rear side board, a left side board and a right side board. When the main body is assembled, it is further sealed by a predetermined type of glue so a receiving space is formed inside the main body, and the main body has a couple air inlets and an air outlet. In one embodiment, the first air inlet is disposed at a lower portion of the left side board and the second air inlet is disposed at a lower portion of the right side board; and the air outlet is disposed on the top board.

The battery module is located in the main body, and the battery module may include a supporting unit, a plurality of electrodes on the supporting unit, an anode connecting unit and a cathode connecting unit. In one embodiment, the anode connecting unit is facing the left side board and the cathode connecting unit is facing the right side board. In a further embodiment, the anode connecting unit and the cathode connecting unit are made by aluminum materials with great heat dissipation property.

The first fan unit and the second fan unit are located in the main body, which are used to suck the air from the first and second air inlets into the main body, and the air goes out from the air outlet. In one embodiment, the first fan unit is located underneath the anode connecting unit. It is noted that a first installation trough is located at a lower portion of the left side board, and the first air inlet is located at a bottom portion of the first installation trough. Similarly, the second fan unit is located underneath the cathode connecting unit. It is noted that a second installation trough is located at a lower portion of the right side board, and the second air inlet is located at a bottom portion of the second installation trough.

The first heat conducting unit is located between the anode connecting unit and the inner sidewall of the main body, and more specifically, the first heat conducting unit is attached to the inner sidewall of the main body. In one embodiment, the first heat conducting unit is made by silicone. Similarly, the second heat conducting unit is located between the cathode connecting unit and the inner sidewall of the main body, and more specifically, the second heat conducting unit is attached to the inner sidewall of the main body. In one embodiment, the second heat conducting unit is made by silicone.

Since the heat generated by the electrode is on both anode and cathode thereof, which are in contact with the anode connecting unit and the cathode connecting unit, so the heat can be transmitted to the anode connecting unit and the cathode connecting unit, and then to the main body through the first heat conducting unit and the second heat conducting unit, so the heat can be continuously dissipated to the environment. Therefore, the temperature of the electrode can be controlled within a predetermined range.

In another aspect, a first heat dissipation channel is formed on the surface of the anode connecting unit, and a second heat dissipation channel is formed on the surface of the cathode connecting unit. In one embodiment, the first heat dissipation channel and the second heat dissipation channel are lineally arranged near the electrode to reduce the resistance of the airflow to achieve the goal of quick heat dissipation. The battery may also include a temperature sensor disposed in the first heat dissipation channel and the second heat dissipation channel to detect the temperature therein.

### BRIEF DESCRIPTION OF THE DRAWINGS

FIG. 1 is an exploded view of the lithium battery with fast charging capability for an autonomous floor-cleaning apparatus in the present invention.

FIG. 2 illustrates a schematic view of the lithium battery with fast charging capability for an autonomous floor-cleaning apparatus in the present invention.

FIG. 3 illustrates a left-side view of the lithium battery with fast charging capability for an autonomous floor-cleaning apparatus in the present invention.

FIG. 4 illustrates a right-side view of the lithium battery with fast charging capability for an autonomous floor-cleaning apparatus in the present invention.

FIG. 5 illustrates a top view of the lithium battery with fast charging capability for an autonomous floor-cleaning apparatus in the present invention.

FIG. 6 illustrates a top view of the lithium battery with fast charging capability for an autonomous floor-cleaning apparatus without the top board in the present invention.

FIG. 7 illustrates a schematic view of the anode connecting unit in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

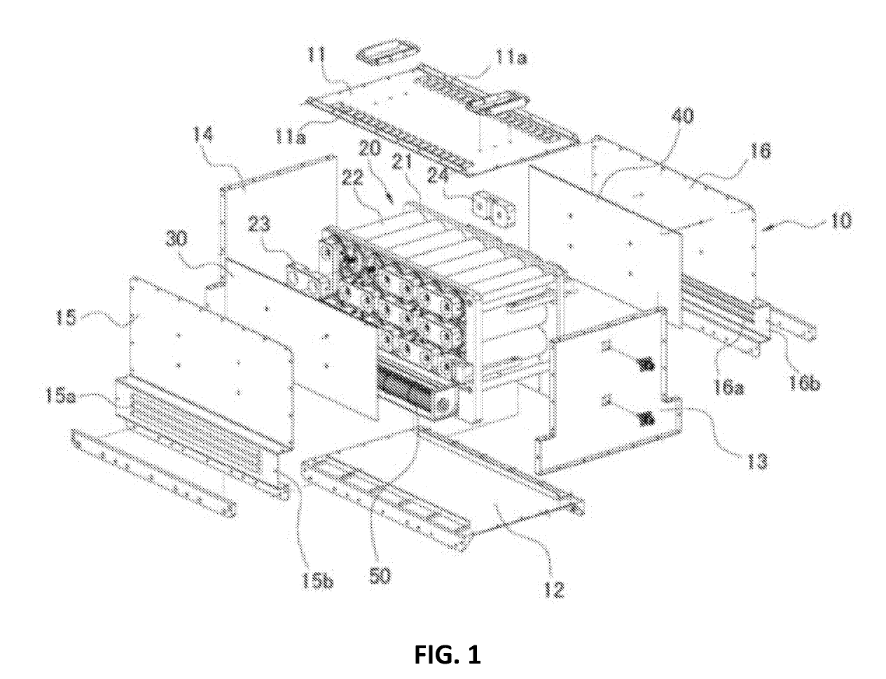

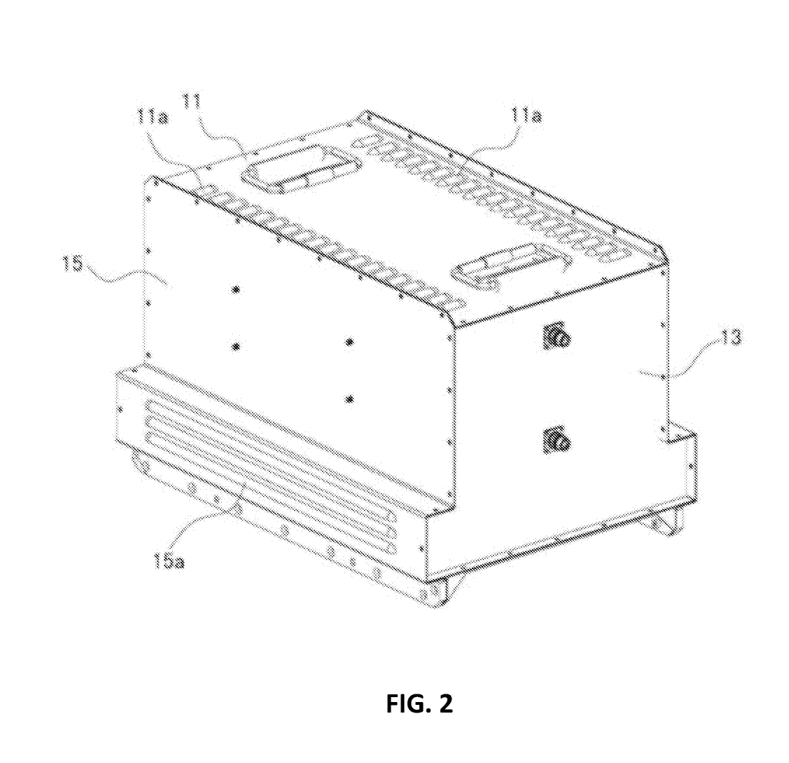

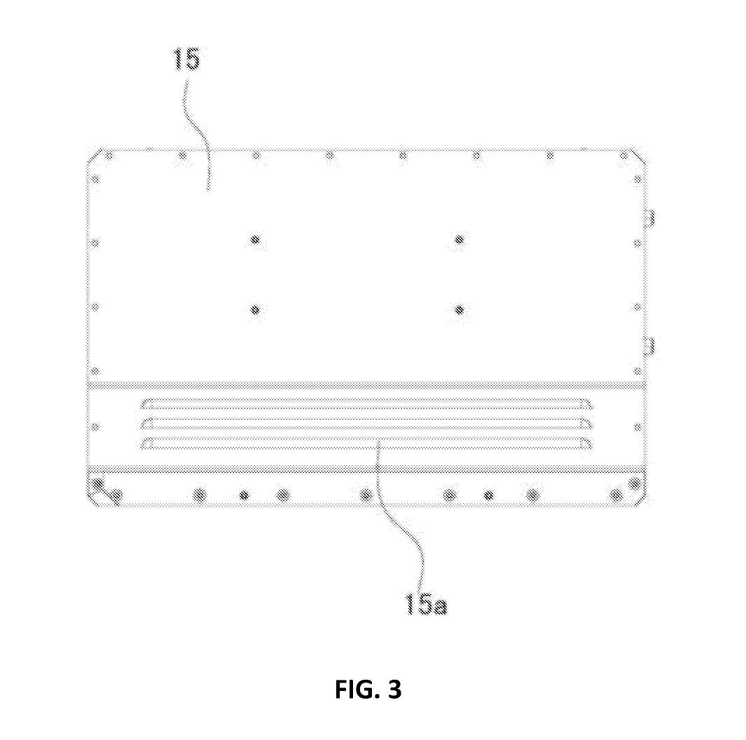

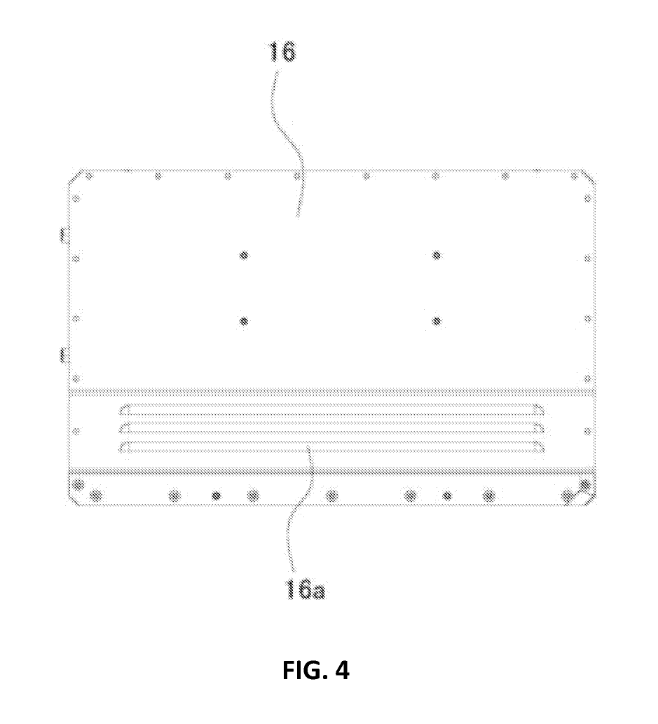

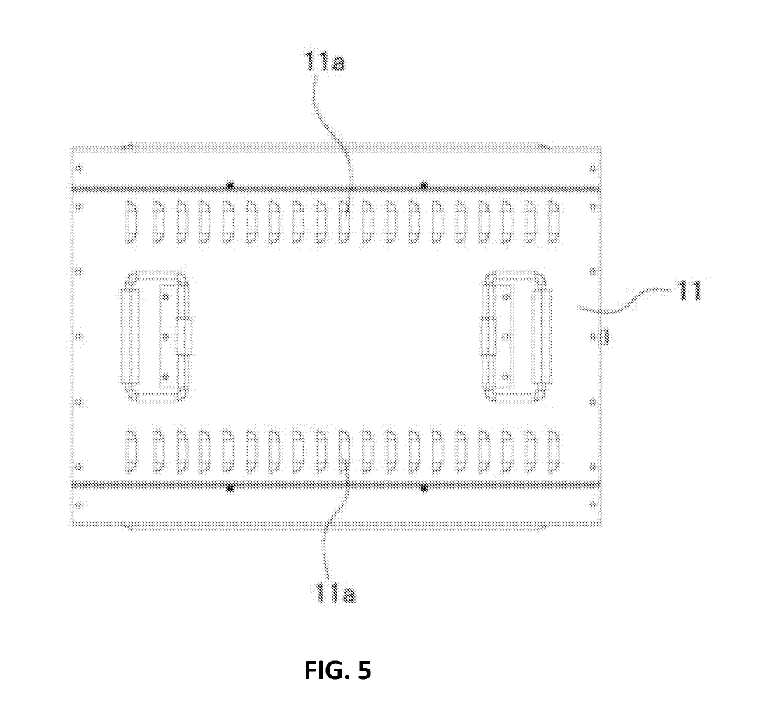

In one aspect, as shown in FIGS. 1 to 5, a lithium battery with fast charging capability for an autonomous floor-cleaning apparatus may include a main body 10, a battery module 20, a first heat conducting unit 30, a second heat conducting unit 40, a first fan unit 50 and a second fan unit 60. In one embodiment, the main body 10 is made by metals with high heat conduction capability, and the main body 10 may include a top board 11, a bottom board 12, a front side board 13, a rear side board 14, a left side board 15 and a right side board 16. When the main body 10 is assembled, it is further sealed by a predetermined type of glue so a receiving space is formed inside the main body 10, and the main body has a couple air inlets 15a, 16a and an air outlet 11a. In one embodiment, the air inlet 15a is disposed at a lower portion of the left side board 15 and the air inlet 16a is disposed at a lower portion of the right side board 16; and the air outlet 11a is disposed on the top board 11.

The battery module 20 is located in the main body 10, and the battery module 20 may include a supporting unit 21, a plurality of electrodes 22 on the supporting unit 21, an anode connecting unit 23 and a cathode connecting unit 24. In one embodiment, the anode connecting unit 23 is facing the left side board 15 and the cathode connecting unit 24 is facing the right side board 16. In a further embodiment, the anode connecting unit 23 and the cathode connecting unit 24 are made by aluminum materials with great heat dissipation property.

The first fan unit 50 and the second fan unit 60 are located in the main body 10, which are used to suck the air from the air inlets 15a and 16a into the main body 10, and the air goes out from the air outlet 11a. In one embodiment, the first fan unit 50 is located underneath the anode connecting unit 23. It is noted that a first installation trough 15b is located at a lower portion of the left side board 15, and the air inlet 15a is located at a bottom portion of the first installation trough 15b. Similarly, the second fan unit 60 is located underneath the cathode connecting unit 24. It is noted that a second installation trough 16b is located at a lower portion of the right side board 16, and the air inlet 16a is located at a bottom portion of the second installation trough 16b.

The first heat conducting unit 30 is located between the anode connecting unit 23 and the inner sidewall of the main body 10, and more specifically, the first heat conducting unit 30 is attached to the inner sidewall of the main body 10. In one embodiment, the first heat conducting unit 30 is made by silicone. Similarly, the second heat conducting unit 40 is located between the cathode connecting unit 24 and the inner sidewall of the main body 10, and more specifically, the second heat conducting unit 40 is attached to the inner sidewall of the main body 10. In one embodiment, the second heat conducting unit 40 is made by silicone.

Since the heat generated by the electrode 22 is on both anode and cathode thereof, which are in contact with the anode connecting unit 23 and the cathode connecting unit 24, so the heat can be transmitted to the anode connecting unit 23 and the cathode connecting unit 24, and then to the main body 10 through the first heat conducting unit 30 and the second heat conducting unit 40, so the heat can be continuously dissipated to the environment. Therefore, the temperature of the electrode 22 can be controlled within a predetermined range.

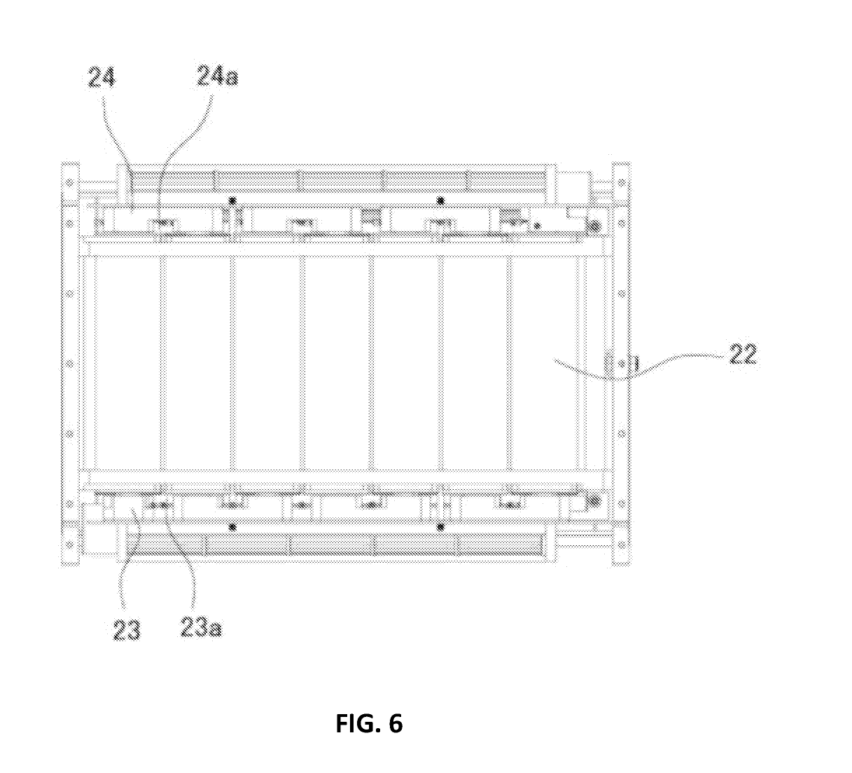

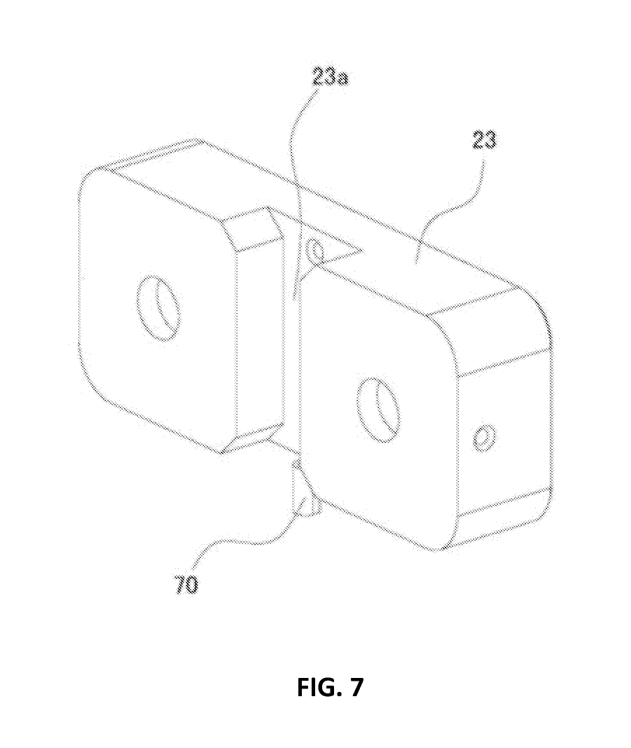

In another aspect, as shown in FIGS. 6 and 7, a first heat dissipation channel 23 is formed on the surface of the anode connecting unit 23, and a second heat dissipation channel 24 is formed on the surface of the cathode connecting unit 24. In one embodiment, the first heat dissipation channel 23 and the second heat dissipation channel 24 are lineally arranged near the electrode 22 to reduce the resistance of the airflow to achieve the goal of quick heat dissipation. The battery may also include a temperature sensor 70 disposed in the first heat dissipation channel 23 and the second heat dissipation channel 24 to detect the temperature therein.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A lithium battery with fast charging capability for an autonomous floor-cleaning apparatus comprising a main body, a battery module, a first heat conducting unit, a second heat conducting unit, a first fan unit and a second fan unit. wherein, the main body is made by metals with high heat conduction capability, and the main body includes a top board, a bottom board, a front side board, a rear side board, a left side board and a right side board, wherein when the main body is assembled, it is further sealed by a predetermined type of glue so a receiving space is formed inside the main body, and the main body has a first air inlet, a second air inlet, and an air outlet; the first air inlet is disposed at a lower portion of the left side board, the second air inlet is disposed at a lower portion of the right side board; and the air outlet is disposed on the top board.

2. The lithium battery with fast charging capability for an autonomous floor-cleaning apparatus, wherein the battery module is located in the main body, and the battery module includes a supporting unit, a plurality of electrodes on the supporting unit, an anode connecting unit and a cathode connecting unit; and the anode connecting unit is facing the left side board and the cathode connecting unit is facing the right side board.
